(19) United States
(12) Patent Application Publication
(10) Pub. No.: US 2006/0046693 A1
(43) Pub. Date: Mar. 2, 2006

(54) Wireless local area network (WLAN) authentication method, WLAN client and WLAN service node (WSN)

(76) Inventors: Hung Tran, Town Mont Royal (CA); Samy Touati, Rosemere (CA)

Correspondence Address: SANDRA BEAUCHESNE;Ericsson Canada Inc., Patent Department (LMC/M/P), 8400 Decarie Blvd., Town Mount Royal, QC, H4P 2N2, CA

(21) Appl. No.: 10/929,403

(22) Filed: Aug. 31, 2004

(51) Int. Cl. H04B 7/216

(52) U.S. Cl. 455/411

(57) ABSTRACT

A method, Wireless Local Area Network (WLAN) client, and WLAN Service Node (WSN) that allows an Extensible Authentication Protocol—Subscriber Information module (EAP-SIM) module of the WLAN client, which module may be wither downloaded from the Internet or pre-installed in the WLAN client, to extract user credentials from a Subscriber Information Module (SIM) card, and to package the credentials into the EAP-SIM format and further into the TCP/IP format, before sending them to the WSN via a serving Access Point (AP). The WSN receives the credentials and unpacks them from the TCP/IP format and further from the EAP-SIM format, and authenticates/authorizes the WLAN client. WLAN access is authorized for the WLAN client upon successful authorization.

### BACKGROUND OF THE INVENTION

1. Field of the Invention

The present invention relates to a method and system for Wireless Local Area Network (WLAN) authentication.

2. Description of the Related Art

A Wireless Local Area Network (WLAN) is a network in which a mobile subscriber can connect to a Local Area Network (LAN) through a radio link. The Institute of Electrical and Electronics Engineers (IEEE) has issued a series of technical specifications, including the 802.11 specification, which lay down the technologies used for WLANs, including an encryption method called the Wired Equivalent Privacy Algorithm. With WLAN, high bandwidth allocation makes possible relatively low-cost connection to the Internet, as WLAN Access Points (APs) begin to be installed not only in corporations and public buildings, but also in densely populated outdoor areas, thus insuring mobile Internet connections for mobile subscribers equipped with computers having a WLAN adapter, which oftentimes takes the form of a PCMCIA (Personal Computer Memory Card Industry Association) cards.

IEEE's 802.11 is an evolving family of technical specification for WLAN, which makes use of the Ethernet protocol and of the Carrier Sense Multiple Access with Collision Avoidance (CSMA/CA) for path sharing. Reference is made to FIG. 3 (Prior Art), which shows a list 50 of existing IETF's specifications for WLANs, along with a brief explanation of each such specification, which are all herein included by reference in their entirety.

Reference is now made to FIG. 1 (Prior Art), which shows a high-level network diagram of a typical WLAN 100, which functions based on the IEEE specification 802.11. The WLAN 100 comprises a plurality of WLAN clients 102 and 104, a plurality of APs among which only the AP 106 is shown for simplicity purposes. The AP 106 provides WLAN radio connection to the clients 102 and 104 on one side and, on the other side, connects to a WLAN Service Node (WSN) 108, which is responsible for relaying data traffic to and from the Internet. The WSN 108 allows a connection to be established between the WLAN clients 102 and 104 up to the Internet 110. In a typical scenario, a WLAN client such as for example the WLAN client 102 connects to the AP 106 and performs a basic authentication procedure with the AP, which may involve username and passwords authorization and credit card information exchange between the client and AP. This credential information related to the WLAN client 102 may be transmitted to a particular Web Server (not shown) of the Internet 110 for authenticating the WLAN client before full Internet access is allowed. Once the client is successfully registered, it can connect through the WSN 108 to the Internet 110. Thus, the 802.11 specification allows for basic web-based authentication of WLAN clients.

One improvement over the above-described 802.11 WLAN is the IEEE's 802.1x specification, which is designed to enhance WLAN security, and provides an additional and more complex authentication framework for WLANs, which allows the user to be authenticated by a central authority. The actual algorithm that is used to determine whether the user is authentic is left open and multiple algorithms are therefore possible. 802.1x uses an existing protocol called the Extensible Authentication Protocol (EAP, RFC 2284) that works on Ethernet, Token Ring, or WLAN for message exchange during the authentication process. In a WLAN based on 802.1x, the user is known as the supplicant and requests access from an AP known as the authenticator, which forces the user into a pre-authorized state that allows the transmission of only an EAP start message. The AP then returns an EAP message requesting the user's identity, which is returned to the AP and forwarded to a central authentication server. The later authenticates the user and returns an accept or a reject message back to the AP. If the user is accepted, the AP changes the client's state to authorized and normal data traffic can then take place between the client, the WLAN, and the Internet.

On the other hand, in the general System for Mobile communications (GSM) as well as in the general Packet Radio Service (GPRS) networks, Subscriber Identification Module (SIM) cards are used to provide authentication for voice and data networks. With the introduction of the WLANs, which complement existing GSM/GPRS networks, the operators desire to provide a unified method of authentication for their subscribers based on the subscriber credentials contained in the SIM cards.

FIG. 2 shows another high-level network diagram of a 802.1x WLAN network 200, in which 802.1.x capable WLAN clients 202 and 204 connect to a 802.1x capable WLAN AP 206 using a WLAN radio interface. The AP 206 is further connected to a WLAN WSN 208 and to an Authentication, Authorization, and Accounting (AAA) server 210, which is responsible for authenticating and authorizing WLAN clients on behalf of the network, and that may also be responsible for generating accounting for the service and/or data traffic. The AAA server 210 may also be connected to a Home Location Register (HLR) 212, responsible for storing subscriber profile information such as for example subscriber services, subscriber accounting information etc. The WSN 208 finally connects to the Internet 209. In FIG. 2, for example, the WLAN client 204 contains a supplicant 205 that acts as an authentication client on behalf of the WLAN client 204, and which may use various authentication protocols such as for example Light Extensible Authorization Protocol (LEAP), Protected Extensible Authentication Protocol (PEAP), EAP-SIM, Message Digest 5 (MD5), etc. During the initial contact with the WLAN 200 the Supplicant 205, which in the present exemplary scenario is assumed to use EAP-SIM authentication protocol, packages the credential information of the WLAN client 204 in the EAP format and sends it to the AP 206. An EAP-SIM authenticator module 207 of the AP 206 receives and unpacks the client's credentials and maps them into, for example, a Remote Authentication Dial-In User Server/Service (RADIUS) message, which it sends to the AAA server 210. The later, possibly in combination with the HLR 212, authenticates and authorizes the WLAN client 204, and in case the authentication is successful, it returns to the AP 206 an authorization message. At that point, because it received the authorization message, the AP 206 allows data traffic to be exchanged by the WLAN client 204, via the AP 206 and the WSN 209.

However, it has been noticed that the prior art implementation shown in FIG. 2 oftentimes requires a software upgrade of the WLAN's APs that have been already deployed in existing commercial WLANs. The vast majority of existing APs are 802.11 APs, which cannot support the 802.1x authentication procedure shown in FIG. 2. Upgrading these 802.11 APs to support the authentication procedures of 802.1x requires software updates on each such AP, which is effort consuming and costly.

On the other hand, it would be advantageous for WLAN operators to have a method and system that supports authentication procedures defined in 802.1.x without the need of modifying existing APs. It would be an even further advantage to have a method and system that supports integrated authentication of both GSM/GRPS and WLAN clients.

The present invention provides such a solution.

### SUMMARY OF THE INVENTION

In one aspect, the present invention is a Wireless Local Area Network (WLAN) client comprising:
a Subscriber Information Module (SIM) card storing a subscriber profile;
an Extensible Authentication Protocol—Subscriber Information module (EAP-SIM) applet supporting EAP-SIM authentication; and
a Transport Control Protocol/Internet Protocol (TCP/IP) stack module;
wherein the EAP-SIM applet functions to extract subscriber credentials from the SIM card, encapsulates the subscriber credentials into EAP-SIM format, and wherein the TCP/IP stack module further encapsulates the subscriber credentials encapsulated into the EAP-SIM format into TCP/IP format before the subscriber credentials are transmitted by the WLAN client to the WLAN.

In another aspect, the present invention is a Wireless Local Area Network (WLAN) Service Node (WSN) comprising:
a Transport Control Protocol/Internet Protocol (TCP/IP) stack module;
an Extensible Authentication Protocol—Subscriber Information module (EAP-SIM) module; and
an authenticator module;
wherein when the WSN receives a WLAN client authentication message comprising subscriber credentials encapsulated in EAP-SIM format and in TCP/IP format, the TCP/IP stack module decapsulates the subscriber credentials from the TCP/IP format, the EAP-SIM module further decapsulates the subscriber credentials from the EAP-SIM format, and the authenticator authenticates the WLAN client using the subscriber credentials.

In yet another aspect, the present invention is a method for Wireless Local Area Network (WLAN) client authentication comprising the steps of:
a. extracting subscriber credentials from a Subscriber Information Module (SIM) card of a WLAN client;
b. encapsulating the subscriber credentials into Extensible Authentication Protocol—Subscriber Information Module (EAP-SIM) format;
c. encapsulating the subscriber credentials encapsulated into the EAP-SIM format into Transport Control Protocol/Internet Protocol (TCP/IP) format; and
d. sending the subscriber credentials from the WLAN client to the WLAN.

In yet another aspect, the present invention is a method for Wireless Local Area Network (WLAN) client authentication comprising the steps of:
a. receiving a WLAN client authentication message comprising subscriber credentials encapsulated in EAP-SIM format and in TCP/IP format at a WLAN Service Node (WSN);
b. decapsulating the subscriber credentials from the TCP/IP format;
c. decapsulating the subscriber credentials from the EAP-SIM format; and
d. authenticating the WLAN client using the subscriber credentials.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a high-level network diagram of a typical Wireless Local Area Network (WLAN) based on the Institute of Electrical and Electronics Engineers (IEEE) specification 802.11;

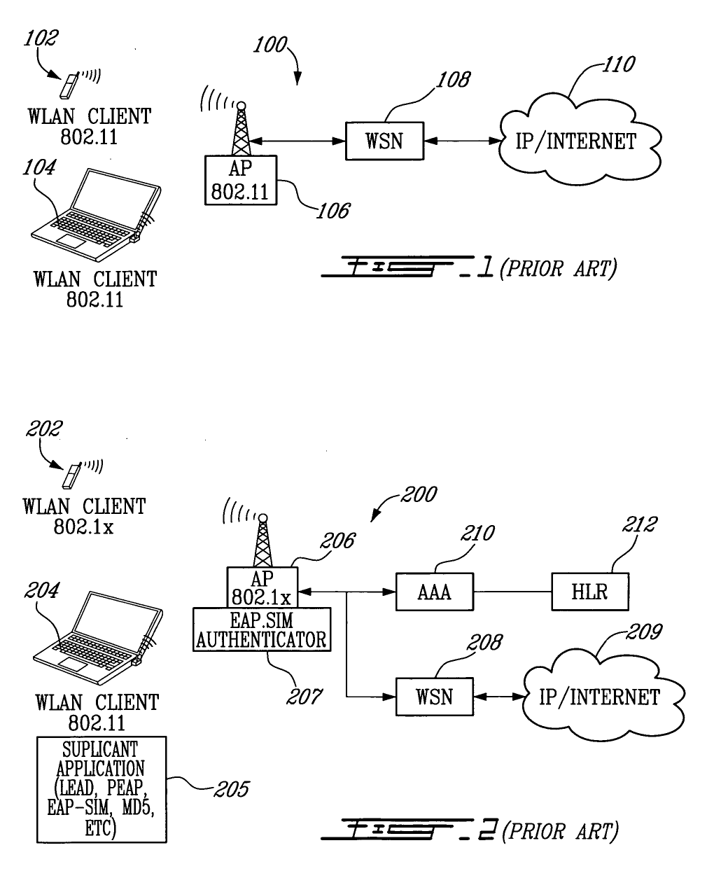

FIG. 2 (Prior Art) is high-level network diagram of a typical WLAN network based on the IEEE specification 802.1x;

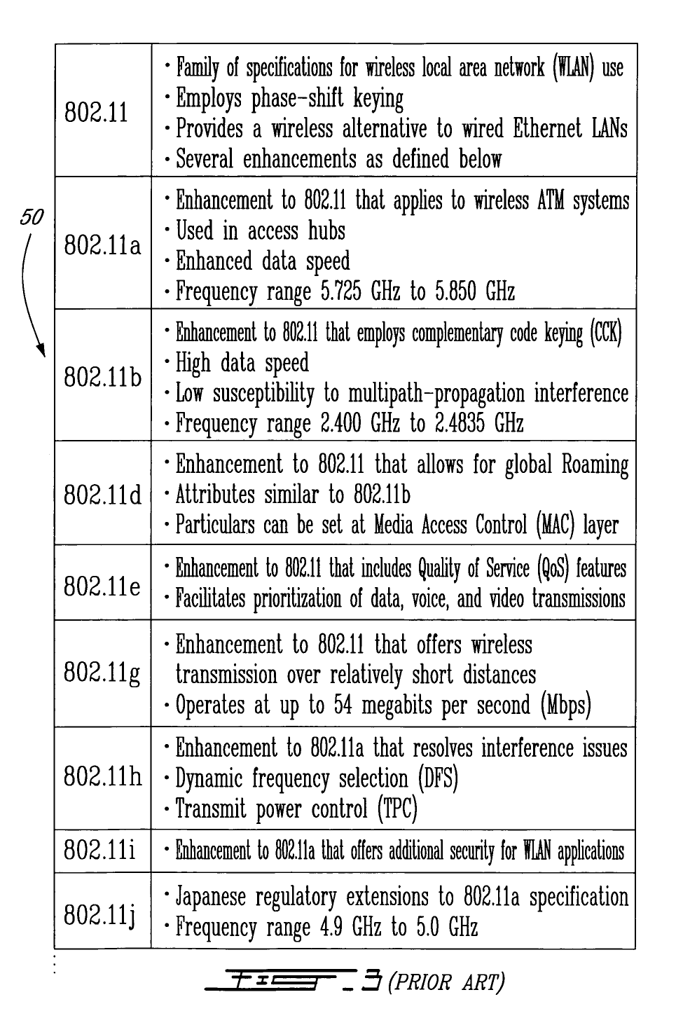

FIG. 3 (Prior Art) is a list of existing specifications for WLANs along with a brief explanation of each such specification;

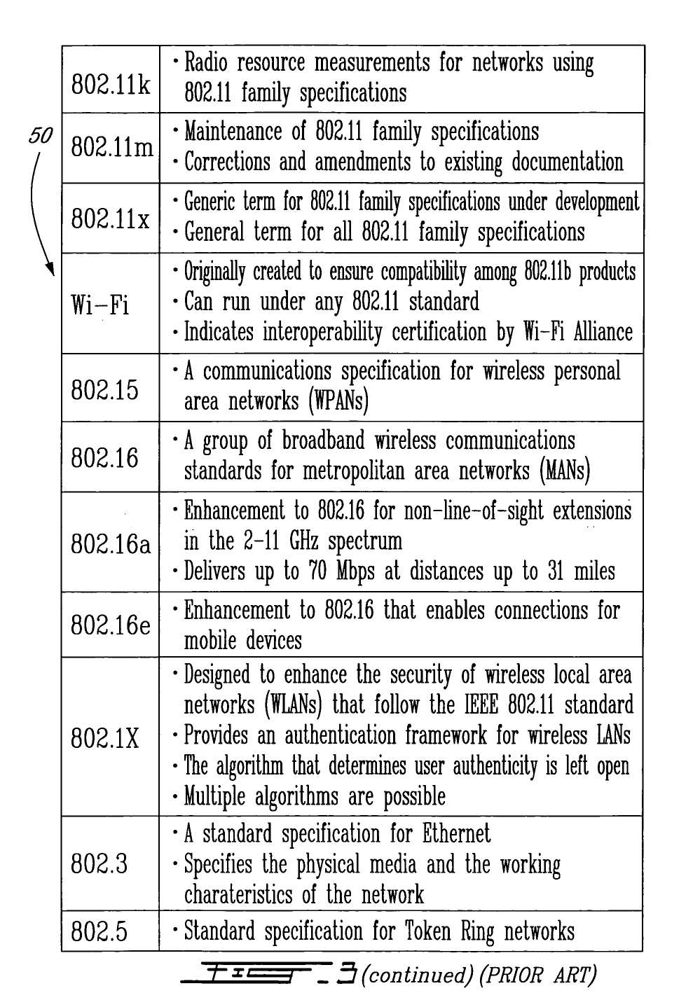

FIG. 4 is an exemplary high-level network diagram of a WLAN based on the IEEE specification 802.1x that also implements the preferred embodiment of the present invention;

FIG. 5 is an exemplary high-level block diagram illustrative of a protocol stack according to the preferred embodiment of the present invention; and

FIG. 6 is exemplary flowchart diagram of a method for WLAN authentication according to the preferred embodiment of the present invention.

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention takes advantage of the fact that in Wireless Local Area Networks (WLANs) functioning according to the Institute of Electrical and Electronics Engineers (IEEE) specification 802.1x, the IP negotiation process between a WLAN client and the serving Access Point (AP) provides for the assignment of an IP address to the WLAN client before the actual authentication procedure takes place. According to the present invention, instead of performing the client's authentication process between the WLAN clients and the serving AP as in the prior art, which requires modifications and update of the APs' software, once the IP address is assigned to the WLAN client, an Extensible Authentication Protocol—Subscriber Information module (EAP-SIM) applet of the WLAN client extracts the credentials of the WLAN client from the client's terminal SIM card, and packages them into the Transfer Control Protocol/Internet Protocol (TCP/IP) format, for sending them over the 802.1.x connection via the serving AP up to the serving WLAN Service Node (WSN) that is in charge of the WLAN client's authentication.

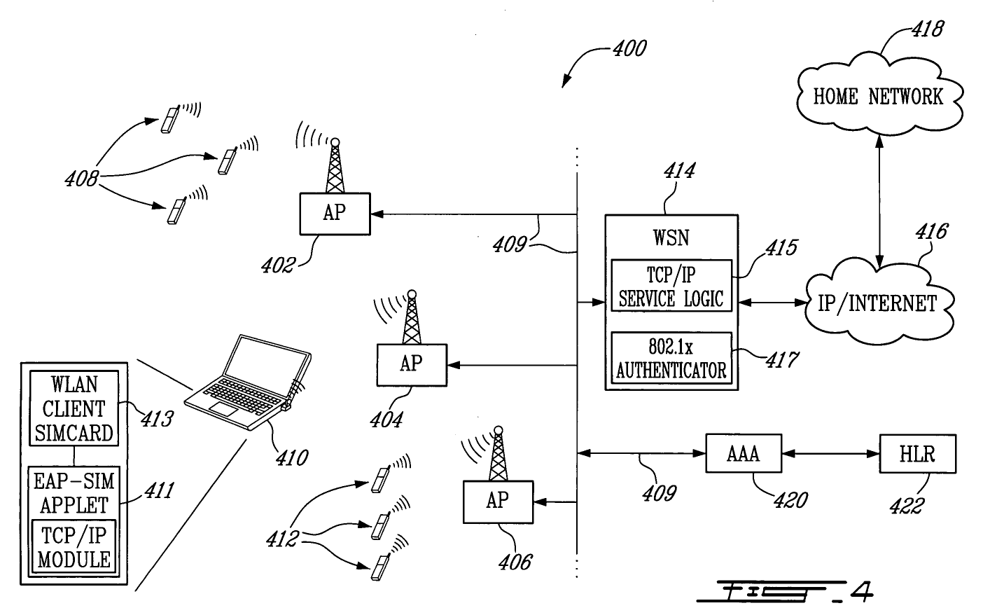

Reference is now made to FIG. 4, which is an exemplary high-level network diagram of a WLAN 400 that functions according to the IEEE's specification 802.1x and that also implements the preferred embodiment of the present invention. Shown in FIG. 4 is the WLAN network 400 that comprises APs 402, 404 and 406, each serving WLAN clients 408, 410, and 412 respectively. Each such WLAN client may be, for example, laptop or notebook computers equipped with Personal Computer Memory Card Industry Association (PCMCIA) cards, wireless Personal Digital Assistants (PDAs), mobile phones, or any other type of terminal that supports WLAN connections. The APs 402, 404, and 406 communicate via appropriate communications interfaces and connections 409 with a WLAN Service Node (WSN) 414, which is responsible for relaying the data traffic from the APs to any IP based network 416, such as for example to the Internet. The IP based network 416 may further connect to a home network 418 of any one of the WLAN clients 408, 410, or 412. At the same time, the APs 402, 404, and 406 may also connect via appropriate communications interfaces 409 to an Authorization, Authentication, and Accounting (AAA) server 420, which may be responsible for authenticating and authorizing access for the WLAN clients to the WLAN network 400. For this purpose, the AAA server 420 may be further connected to a Home Location Register (HLR) 422 that may store subscribers' profiles including subscription details, accounting information, etc.

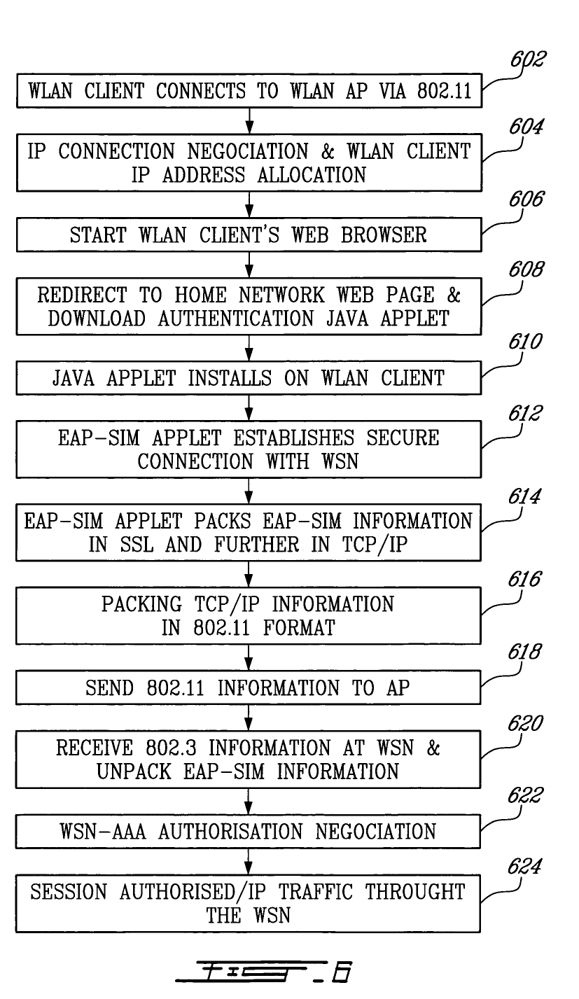

Reference is now made jointly to FIG. 4, previously described, and to FIG. 6, which is an exemplary flowchart diagram of a method for WLAN authentication according to the preferred embodiment of the present invention. When a WLAN client, such as for example for the WLAN client 410 desires to establish a new WLAN connection with the WLAN 400, it first connects to an AP that serves the area where the WLAN client is located, which in the present exemplary case is considered to be the AP 404, action 602. In action 604, the WLAN client 410 participates in the IP connection negotiation with the serving AP 404 and obtains an IP address assigned by the WLAN 400.

Optionally, in action 606, the WLAN client may be instructed to automatically start its web browser application and be redirected in action 608 to connect to its home network web page, or to any other pre-determined default web page of the Internet 416, in order to download an authentication Java applet that supports the EAP-SIM authentication protocol. In such a case, in action 610, the downloaded EAP-SIM Java applet 411 is installed in the WLAN client 410. In another variant of the preferred embodiment of the invention, the EAP-SIM applet 411 may be pre-installed in the WLAN client 410, in which case the actions 608-610 may be skipped.

Further, in action 612, the EAP-SIM Java applet 411 is started and establishes a secured connection with the WSN 414 via the serving AP 404. The secured connection may be established via the well-known Secure Sockets Layer (SSL) protocol, although other security mechanisms may be used as well. Then, the EAP-SIM Java applet 411 extracts the user credentials from the SIM card 413 of the WLAN client 410, and in action 614 encapsulates the user credentials in the EAP-SIM format, then further encapsulates the obtained EAP-SIM information into SSL format in order to render its secured. Finally, the SSL information is further encapsulated into the TCP/IP format (first in TCP and then in IP format). In action 616, the obtained TCP/IP information may further be encapsulated into 802.11 format by the WLAN client 410, and is sent in action 618 to the serving AP 404, which may format it in 802.3 (Ethernet) format and send it to the WSN 414. The later receives the WLAN client's credentials and in action 620 in 802.3 format, and decapsulates the received information and extracts the WLAN client's credentials. For this purpose, the WSN 414 may comprise a TCP/IP service logic module 415, which is responsible for the decapsulation of the TCP/IP information received from the WLAN client 410 and for the transmission of the user credentials to an authenticator 417, which is a module within the WSN 414 responsible for authenticating the WLAN client 410 based on its credentials. In action 622, the authenticator 417 of the WSN 414 becomes involved in an authorization negotiation with the AAA server 420, to which it sends the WLAN client credentials. The AAA server 420, alone or in combination with the HLR 422, determines whether or not the WLAN client 410 should be allowed access to the WLAN network 400 and the Internet 416 based on its service subscription. In the affirmative, i.e. if the WLAN access is allowed for the WLAN client 410, in action 624, the WSN 414 authorizes the WLAN session for the WLAN client 410, and IP data traffic is allowed to be exchanged between the WLAN client 410 and the IP based network 416 via the serving WSN 414.

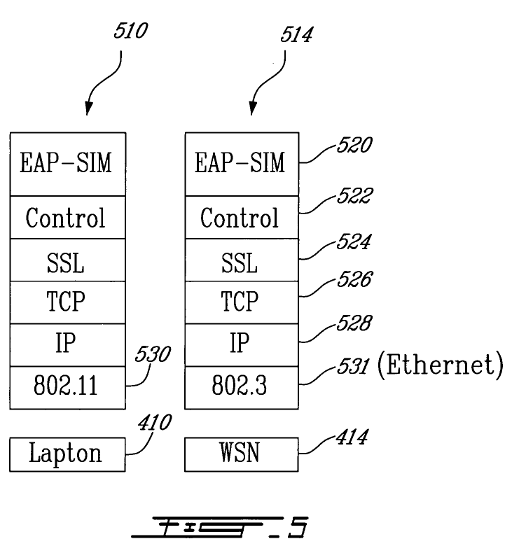

FIG. 5 is an exemplary high-level block diagram illustrative of a protocol stack according to the preferred embodiment of the present invention. Shown in FIG. 5 is the WLAN client 410 along with the WSN 414 along with their respective protocol stacks 510 and 514. FIG. 5 shows the user credentials extracted from the SIM card 413 of the WLAN client 410, which are first encapsulated in EAP-SIM format 520, to which it is added a control overhead 522. This information is further encapsulated in, for example, SSL format 524 in order to ensure the security of the data exchange. The SSL packets are finally encapsulated in TCP format 526 and further in IP format 528. Lastly, the TCP/IP data packets are encapsulated in WLAN 802.11 data format. At the receiving end, i.e. at the WSN 414, a reverse process of decapsulation takes place, except for the 802.11 format which is replaced with the 802.3 format (Ethernet format).

Therefore, with the present invention it becomes possible to implement 802.1x authentication mechanism without the need of updating existing APs that only support 802.11, by implementing authentication functionality into the WSN instead of the APs. Because one WSN controls a plurality of APs, it is more efficient and cost-effective to implement the authenticator functionality into the WSN.

Based upon the foregoing, it should now be apparent to those of ordinary skills in the art that the present invention provides an advantageous solution, which offers efficient authentication functionality in WLANs that function based on IEEE's 802.1.x specification, which is herein included by reference in its entirety. It should be realized upon reference hereto that the innovative teachings contained herein are not necessarily limited to the above-described exemplary scenarios. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A Wireless Local Area Network (WLAN) client comprising:
a Subscriber Information Module (SIM) card storing a subscriber profile;
an Extensible Authentication Protocol—Subscriber Information module (EAP-SIM) applet supporting EAP-SIM authentication; and
a Transport Control Protocol/Internet Protocol (TCP/IP) stack module;
wherein the EAP-SIM applet functions to extract subscriber credentials from the SIM card, encapsulates the subscriber credentials into EAP-SIM format, and wherein the TCP/IP stack module further encapsulates the subscriber credentials encapsulated into the EAP-SIM format into TCP/IP format before the subscriber credentials are transmitted by the WLAN client to a WLAN.

2. The WLAN client of claim 1, wherein the TCP/IP stack module is comprised in the EAP-SIM applet.

3. The WLAN client of claim 1, wherein the EAP-SIM applet is an EAP-SIM Java applet.

4. The WLAN client of claim 1, wherein the EAP-SIM applet is downloaded by the WLAN client following an allocation of an IP address for the client by the WLAN.

5. The WLAN client of claim 1, wherein the EAP-SIM applet is pre-installed in the WLAN client.

6. The WLAN client of claim 1, wherein the subscriber credentials are sent to a WLAN Service Node (WSN) of the WLAN for authenticating the WLAN client.

7. A Wireless Local Area Network (WLAN) Service Node (WSN) comprising:
a Transport Control Protocol/Internet Protocol (TCP/IP) stack module;
an Extensible Authentication Protocol—Subscriber Information module (EAP-SIM) module; and
an authenticator module;
wherein when the WSN receives a WLAN client authentication message comprising subscriber credentials encapsulated in EAP-SIM format and in TCP/IP format, the TCP/IP stack module decapsulates the subscriber credentials from the TCP/IP format, the EAP-SIM module further decapsulates the subscriber credentials from the EAP-SIM format, and the authenticator authenticates the WLAN client using the subscriber credentials.

8. The WSN client of claim 7, wherein the subscriber credentials are sent from the WLAN client to the WSN via a serving Access Point (AP).

9. The WSN client of claim 7, wherein the authenticator authenticates the WLAN client using the subscriber credentials by contacting an Authorization, Authentication and Accounting (AAA) server.

10. A method for Wireless Local Area Network (WLAN) client authentication comprising the steps of:
a. extracting subscriber credentials from a Subscriber Information Module (SIM) card of a WLAN client;
b. encapsulating the subscriber credentials into Extensible Authentication Protocol—Subscriber Information Module (EAP-SIM) format;
c. encapsulating the subscriber credentials encapsulated into the EAP-SIM format into Transport Control Protocol/Internet Protocol (TCP/IP) format; and
d. sending the subscriber credentials from the WLAN client to the WLAN.

11. The method of claim 10, wherein step a. is performed by an Extensible Authentication Protocol—Subscriber Information module (EAP-SIM) module of the WLAN client.

12. The method of claim 11, wherein the EAP-SIM applet is an EAP-SIM Java applet.

13. The method of claim 11, wherein the EAP-SIM applet is downloaded by the WLAN client following an allocation of an IP address for the client by the WLAN.

14. The method of claim 11, wherein the EAP-SIM applet is pre-installed in the WLAN client.

15. The method of claim 11, wherein the subscriber credentials are sent to a WLAN Service Node (WSN) of the WLAN for authenticating the WLAN client.

16. The method of claim 10, wherein step c. is performed by a TCP/IP module of the WLAN client.

17. A method for Wireless Local Area Network (WLAN) client authentication comprising the steps of:
a. receiving a WLAN client authentication message comprising subscriber credentials encapsulated in EAP-SIM format and in TCP/IP format at a WLAN Service Node (WSN);
b. decapsulating the subscriber credentials from the TCP/IP format;
c. decapsulating the subscriber credentials from the EAP-SIM format; and
d. authenticating the WLAN client using the subscriber credentials.

18. The method of claim 17, wherein step b. is performed by a Transport Control Protocol/Internet Protocol (TCP/IP) stack module of the WSN.

19. The method of claim 17, wherein step c. is performed by an Extensible Authentication Protocol—Subscriber Information module (EAP-SIM) module of the WSN.

20. The method of claim 17, wherein step d. is performed by an authenticator module of the WSN.
